(19) United States
(12) Patent Application Publication
(10) Pub. No.: US 2009/0123766 A1
(43) Pub. Date: May 14, 2009

(54) MODIFIED BARRIER LAYERS IN LINERS FOR CONTAINER CLOSURES, CAPABLE OF PROVIDING VARIBLE, CONTROLLED OXYGEN INGRESS

(75) Inventor: James W. Peck, Modesto, CA (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: G3 ENTERPRISES, Modesto, CA (US)

(21) Appl. No.: 11/939,124

(22) Filed: Nov. 13, 2007

(51) Int. Cl. B28B 11/18; B32B 9/04

(52) U.S. Cl. 428/457; 264/162; 428/411.1

(57) ABSTRACT

A liner for bottle caps and method for controlling the oxygen diffusion rate of closures. The oxygen barrier layer of a laminated cap liner or seal over cork stopper for a container closure, such as a metal foil or PVDC, is provided with perforations, formed, for example, by laser. Perforations permit an increased oxygen diffusion rate as compared to conventional barrier layers having imperforate metal foil, while permitting the liner or seal to retain a lower oxygen diffusion rate as compared to other conventional liners having no oxygen barrier. The oxygen diffusion rate can be further adjusted by changing the cumulative area of perforations in the metal foil of the barrier laminate, by varying the number of perforations, or by varying the size of the individual perforations.

### FIELD OF THE DISCLOSURE

This disclosure relates to seals for containers and, more particularly, to liners for closures of food, beverage or pharmaceutical jars or bottles containing consumable products, most particularly wine, that have at least some tolerance to oxygen exposure (i.e. resistance to spoilage when exposed to oxygen). The liners are formed of a multi-layered laminate, at least one of the liner layers comprising a perforated sheet of barrier material. The perforations in the sheet of barrier material expose more diffusive film layers of the laminate to air, thereby facilitating increased diffusion of oxygen.

### BACKGROUND

In the winemaking industry, there can be a delicate balance between sealing the contents of wine bottles preventing leakage, retain flavor, avoiding contaminants, and stopping product degradation, on the one hand, and permitting some oxygen diffusion into wine bottles to ameliorate unpleasant aromas. An example of such aromas are those that may result from the formation of sulfide compounds, when the wine is starved of oxygen for long periods of time.

While natural cork stoppers have been used as the closures of choice for many generations of wine bottlers, there has recently been growing acceptance of screw caps on wine bottles. A significant obstacle to even greater acceptance of screw capped bottles on the part of the wine industry is the need to ensure that the cap does not adversely affect, but instead maintains or even enhances, a wine's taste and aroma.

Liners used within screw caps for beverage bottles are often composed of multiple layers of materials forming a sandwich or laminate structure. In order for the liner to be effective, at least a perimeter of the liner must be sufficiently flexible to conform to the bottle's sealing surface, or finish, of the rim. The perimeter of the liner is compressed against the finish of the bottle's glass rim by pressure from the metal cap overlying the liner. The engagement of the female threads of the screw cap with complementary male threads near the rim of the bottle provide the needed force to securely hold the liner against the sealing rim of the bottle. Only by conforming to the finish of the bottle can the liner prevent leakage of the contents of the bottle. Moreover, the liner must possess sufficient barrier properties to prevent undesirable contaminants from entering the bottle.

In the case of many foods, pharmaceuticals, and beverages, oxygen is a major cause of product degradation, negatively impacting freshness, effectiveness, and shelf stability of the product. In an effort to prevent oxygen from diffusing through the cap liner into the bottle and subsequently into the product, it is common to include an oxygen barrier layer comprising a PVDC film and metal foil, typically aluminum or tin, in at least one of the liner's laminate layers. Generally, the series of layers of a liner for a screw cap from bottom (i.e., the layer of the liner in contact with the bottle finish and exposed to the food or beverage) to top (i.e., the layer of the liner in contact with the inside of the screw cap) includes:
1) A very thin polymer film layer, typically polyethylene;
2) A barrier layer, that may include a laminate of PVDC, polyethylene laminate or metal foil, and PVDC;
3) A very thin polymer film layer, typically polyethylene;
4) Fiber card (paper) or polymer foam; and
5) Polymer film, typically polyethylene.
   Additional or alternate materials for each of these layers are disclosed below, in the Detailed Description of the Preferred Embodiments. Metal foil is very oxygen-impermeable, providing an excellent barrier to oxygen diffusion. Although PVDC film alone is also an admirable oxygen barrier, it provides an oxygen diffusion rate approximately ten times greater than a metal foil laminate.

As illustrated in the cross-sectional view of FIG. 1, conventional screw cap liners are not completely oxygen-tight. Oxygen fills spaces between male threads of the glass bottle and female threads of the cap, because there is not an oxygen-tight fit at these points. As indicated by the directional arrow referenced “O₂”, oxygen enters from the sides of the liner where there is no barrier layer, travels through the “filler” in the middle of the liner, and then down through the barrier into the bottle head space and the product, which in this case is wine. The diffusion of oxygen is driven by the concentration gradient between the atmosphere outside the bottle (approximately 21% O₂) and the headspace above the wine. Over time, oxygen dissolves into the wine and is consumed by wine components. The oxygen loss from the headspace of a cap-finished bottle, due to this consumption, typically outpaces the rate of oxygen transmission into the package, resulting in the headspace oxygen dropping over time, and eventually approaching zero.

It would be desirable to impart greater control over the oxygen diffusion rate to optimize oxygen diffusion through the barrier layer and other layers of a screw cap's liner. By controlling the oxygen diffusion rate, wine makers can better counteract undesirable aromas that might otherwise be produced, e.g. by sulfide compounds in wines, when starved of oxygen.

The two types of cap liners currently most used in the wine industry are foil/PVDC laminates and PVDC laminates. A standard 30 mm diameter foil cap liner, when well sealed to a bottle, has an oxygen diffusion rate of approximately 0.0002 cc oxygen per 24 hours. A well sealed 30 mm PVDC cap liner has a diffusion rate of approximately 0.002 cc oxygen per 24 hours. At this time, there exists no known production 30 mm diameter screw cap liner for the wine industry that can provide oxygen diffusion rates falling between 0.0002 and 0.002 cc oxygen per 24 hours. Likewise, there is no known 30 mm cap liner available that can provide oxygen diffusion rates falling within the range of 0.002 to 0.006 cc of oxygen per 24 hours. As described in the following sections, the screw cap liner of the present disclosure provides winemakers the ability to choose customized oxygen diffusion rates for their screw cap liners that fall between these values. There may also be circumstances in which oxygen diffusion rates higher than 0.002 cc oxygen per 24 hours are desirable.

Recent studies have shown that the oxygen diffusion rate of natural cork stoppers in inverted bottles (considered by many in the wine industry as having an ideal diffusion rate) falls between that of the foil and PVDC liners. However, when stored in an upright position, natural cork oxygen transmission rates can also be highly variable and cannot be fine tuned with current commercial technologies. The method of manufacture of the present disclosure allows winemakers and wineries to select a screw cap liner from a range of distinct, controlled oxygen diffusion rates so as to optimize the oxygen diffusion for storage of various wines, as well as control the variability of stoppers inserted into wine bottles. A winemaker bottling a white wine, for instance, may desire a screw cap liner with an oxygen diffusion rate of approximately 0.0005 cc per 750 mL bottle per day, and accordingly, can select a screw cap liner made using the technology presented in this disclosure having an oxygen diffusion rate in the range of about 0.0004 to 0.0006 cc O₂ per closure per 24 hours. Similarly, a heavy red wine, which the winemaker wants to age in the bottle, will require more oxygen and could be capped with a screw cap having a liner with a diffusion rate in the range of about 0.0007 to 0.0015 cc O₂ per bottle per 24 hours.

Winemakers can similarly employ heat seals containing a foil laminate as an outer security or sterility “over-seal,” also known in the art as a tamper-evident seal (i.e. a seal to the rim or finish of a bottle), over traditional natural cork stoppers. Such foil seals often are imprinted or embossed with a decorative image, such as a trademark or other unique designation. The oxygen permeability of natural cork stoppers can vary from one to another, and generally, the oxygen permeability of individual natural cork stoppers decreases over time, until a steady state condition is reached. During the first three weeks, the oxygen ingress of natural cork stoppers, on average, is approximately 0.005 to 0.018 cc of O₂ per 24 hours. This initial O₂ is predominantly attributable to the off-gassing of air from the compressed cork. During the following four months, the oxygen permeability of natural cork stoppers decreases, on average to about 0 to 0.0006 cc of O₂ per 24 hours. Paulo Lopes, PhD, University of Bordeaux, “Oxygen ingress through different closures into wine bottles,” A Closer Look at Cork Closures, Technical Seminar, Napa, Calif., 23 Jun. 2006. The variability in oxygen diffusion is believed to be a primary factor in the variability of wine oxidation rates for wines closed with natural cork stoppers.

It is known that natural bark cork stoppers do not always provide an adequate oxygen barrier in wine packages. In wine bottles stored upright, microscopic channels within the cork and/or at the cork-glass interface are occasionally present allowing the passage of oxygen into the bottle, resulting in premature aging and oxidation of the wine. A foil laminate over-seal, which is heat-sealed or adhesively sealed onto the top or finish of the bottle over the cork, is desirable for its oxygen permeability control. As an alternative to natural cork stoppers, synthetic polymer stopper usage has increased in recent years. However, synthetic polymer stoppers have oxygen diffusion rates much higher than most conventional wine closures, and hence cause the wine to have a limited shelf life. As discussed in the following sections, the techniques of the present disclosure, when utilized with an over-seal, provide controlled oxygen diffusion rates for all types of cork wine stoppers, producing consistent rates in bottles closed with bark cork as well as achieving much lower oxygen diffusion rates in bottles closed with synthetic cork, thereby increasing product shelf life and reducing spoilage due to oxidation.

### SUMMARY OF THE DISCLOSURE

Due to off odor issues associated with foil lined caps, which allow virtually no oxygen transmission, and shortened shelf-life issues associated with closures such as caps lined with barrier layers consisting of only PVDC, or natural and synthetic cork stoppers, there is a need for wine closures with custom oxygen transmission rates, providing controlled incremental changes in oxygen diffusion rate.

According to the apparatus and process of the present disclosure, a solid, unbroken sheet of barrier material employed in the laminates of conventional screw cap liners, latch-cap liners, or metal foil tamper-evident seals is replaced with at least one sheet of barrier material that has been perforated, such as by a laser or other mechanical process, prior to being laminated. While the un-perforated portion of the barrier material retains its barrier properties, the perforation(s) in oxygen barrier material will expose the more diffusive film portions of the liner's barrier laminate to the air, thereby allowing increased diffusion of oxygen into the jar or bottle, and thus into the product contained therein.

According to Fick's Law, the rate of gas diffusion is directly dependent upon a material's diffusion constant, its thickness, and the surface area exposed. Therefore, by controlling the area of perforations through the barrier, and using more highly diffusive materials as one element of the barrier laminate, the rate of oxygen diffusion of a cap liner can be adjusted to permit screw cap liners having a continuum of oxygen transmission rates greater than, for example, a screw cap liner with a barrier layer laminate including an unperforated metal foil barrier layer, but less than that of a screw cap liner with a barrier layer consisting only of PVDC film. Additionally, a cap liner containing PVDC laminate as its oxygen barrier can be similarly perforated according to the present disclosure to provide oxygen transmission rates higher than unperforated PVDC.

The greater the number (density) of perforations and/or the greater the size of each perforation through the barrier layer, the greater the area of more diffusive film below the barrier layer that is exposed to oxygen. This results in a greater rate of diffusion of oxygen through the liner. As described in the Background section, above, a primary application for the technology disclosed herein is the wine industry, where the very high oxygen barrier capabilities of existing foil screw cap liners have been associated with the development of “reduced” sulfidic odors attributed to the formation of mercaptans, thiols, and disulfides.

Likewise, by perforating the foil within an over-seal applied to the rim or finish of a bottle, over the top of a bottle finished with a cork, prior to lamination between polymer films, the oxygen ingress of a wine bottle having a cork stopper may be controlled to a desirable level. In the case of screw cap liners, the apparatus and process of the present disclosure is intended to allow the diffusion of a very small, controlled amount of oxygen. When used as an over-seal of a corked bottle, the apparatus and process disclosed herein is intended to place an upper limit on the oxygen diffusion at a desired target level, minimizing the variability of oxygen transmission of natural cork, and compensating for the high oxygen diffusion rate of existing synthetic polymer stoppers.

In at least one embodiment of the present disclosure, the over-seal is a laminate having one or more perforations through all the several layers comprising the laminate. By precisely controlling the size and/or number of the perforation(s), a desired oxygen transmission rate may be achieved.

### BRIEF DESCRIPTION OF THE SEVERAL VIEWS OF THE DRAWING

FIG. 1 is an enlarged side cross-sectional view, partially broken away, of a conventional screw cap and screw cap liner assembly, showing the screw cap threadedly engaged with a threaded end of a glass bottle, and the liner compressed between a finish on the rim of the glass bottle and the metal top of the screw cap;

FIG. 2 is a side cross-sectional view of a cap liner laminate including a barrier layer including only PVDC;

FIG. 3 is a top plan view of a conventional metal foil/PVDC laminate often employed as the barrier layer of a laminate structure of a cap liner;

FIG. 4 is a side cross-sectional view, taken along lines 4-4 of FIG. 3, of the metal foil/PVDC laminate barrier layer of FIG. 3;

FIG. 5 is a top plan view of a metal foil/PVDC laminate barrier layer similar to that of FIGS. 3 and 4, modified according to the teachings of the present disclosure to include a plurality of perforations therein;

FIG. 6 is a side cross-sectional view, taken along lines 6-6 of FIG. 5, of the perforated metal foil/PVDC laminate barrier layer of FIG. 5;

FIG. 7 is a side cross-sectional view of a cap liner laminate including a perforated metal foil/PVDC laminate barrier layer, wherein perforations are provided through the metal foil layer thereof;

FIG. 8 is a side cross-sectional view of a cap liner laminate including a perforated metal foil/PVDC laminate barrier layer similar to that of FIG. 7, wherein perforations are provided through both the metal foil layer and PVDC layer thereof;

FIG. 9 is a side cross-sectional view of a cap liner laminate including a perforated barrier layer wherein the barrier layer laminate includes only a layer of PVDC, and wherein the perforations are provided through the PVDC layer;

FIG. 10 is a top plan view of a metal foil/PVDC laminate barrier layer similar to that of FIGS. 6 and 7, but having a larger number of perforations therein;

FIG. 11 is a top plan view of a metal foil/PVDC laminate barrier layer similar to that of FIGS. 5 and 6, having the same number of perforations therein, but each perforation having a greater diameter, i.e. a larger area;

FIG. 12 is a top plan view of metal foil/PVDC laminate barrier layers for liners in a set of two liners for container closures, with each of the liners within the set having a barrier laminate with a perforated oxygen barrier layer, and having an oxygen diffusion rate different from the other liner of the set; and

FIG. 13 is an enlarged side cross-sectional view, partially broken away, of a corked glass bottle with a perforated over-seal of the present disclosure.

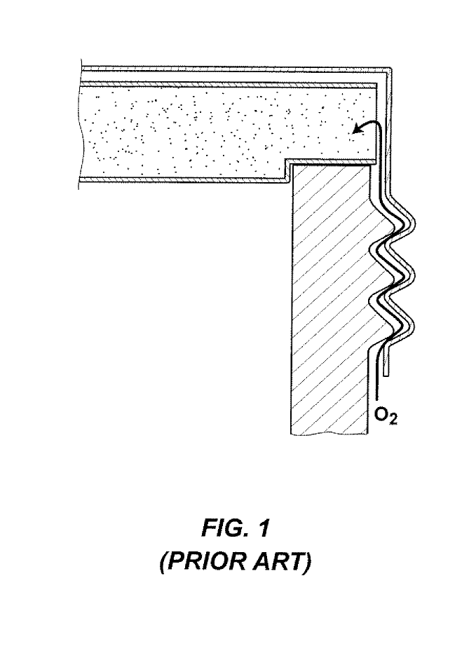

### DETAILED DESCRIPTION OF THE PREFERRED EMBODIMENTS

A liner 10 for a screw cap or a latch-cap for jars or bottles typically includes a series of layers that form a laminate. As used herein, bottles shall be understood to include both bottles and jars. Generally, the series of layers of the cap liner 10 from bottom 12 to top 14 includes: A very thin first polymer film layer 16, typically low-density polyethylene (LDPE), but may additionally or alternatively include one or more of a group of PET, SARAN, EVA, or EVA-Scavenger; a barrier layer disposed on the first polymer film layer, that may itself include a barrier laminate 18 of a PVDC layer 20 alone or in combination with a polyethylene laminate or metal foil 22 (typically aluminum or tin) disposed on the PVDC layer 20; fiber card (paper) 24 or polymer foam (which may include one or more of expanded LDPE foam, LDPE foam-Scavenger, expanded HDPE foam, expanded polypropylene foam, or Kraft paper); and a second polymer film layer 26, typically LDPE, but may additionally or alternatively include one or more of a group of PET, SARAN, EVA, or EVA Scavenger, disposed on a surface of the barrier layer opposite the first polymer film layer. The metal film 22 of the barrier laminate 18 has a very low oxygen diffusion rate, and thereby prevents oxygen from diffusing through the cap liner 10 into the bottle and product contained therein.

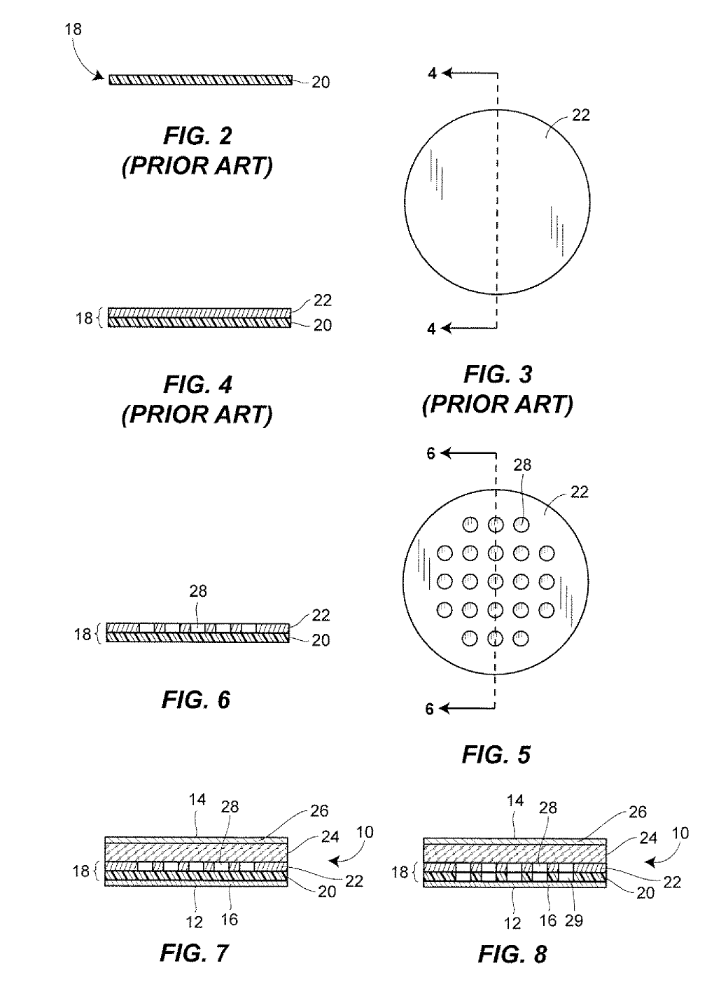

For some products (such as wine), use of a liner having an oxygen diffusion rate as low as that achieved with a barrier laminate 18 having a metal film layer 22 can cause adverse results, such as undesirable sulfidic odors. As shown in FIG. 2, screw cap liners having a barrier laminate 18 having PVDC 20 but no metal film 22 are often used for such products. However, the oxygen diffusion rate of these screw cap liners is significantly higher than that of the cap liner 10 having a barrier laminate 18 such as that shown in FIGS. 3 and 4. Their use can allow too much oxygen into the bottle, shortening product shelf-life. Nevertheless, in the event it were desired to increase the oxygen diffusion rate of such PVDC-only barrier laminates, the teachings of the present disclosure can be applied to do so.

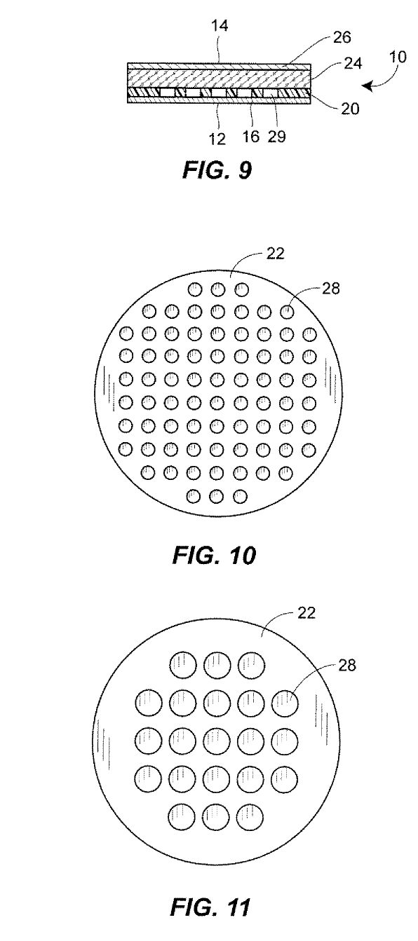

As shown in FIGS. 5-11, various embodiments for cap liners are disclosed herein that achieve an oxygen diffusion rate between that of conventional screw cap liners having PVDC but no metal film in the barrier laminate 18, and cap liners having both a PVDC layer 20 and solid metal film layer 22 within the barrier laminate 18, or even higher than that of a barrier laminate 18 having only a PVDC layer 20, if desired.

As shown in FIG. 5-7, a liner 10 of the present disclosure includes a barrier laminate 18 having perforations 28 in at least one layer thereof. Preferably, the barrier laminate 18 includes a metal film layer 22 with a plurality of perforations 28 formed therein. The perforations may be imparted to the metal film layer 22 by an appropriate means for providing perforations in a foil or polymer film, including laser, electro-discharge machining (EDM), or other precision techniques for drilling apertures through thin metal film.

A cap liner having an even greater oxygen diffusion rate than that of the barrier laminate 18 of FIGS. 5-7 may be achieved by varying the area of perforations in the metal film layer 22. For instance, as illustrated in FIG. 10, a greater number of perforations 28 may be imparted to the metal film layer 22. Alternatively, the size of the individual perforations 28 may be increased, as shown in FIG. 11. While in FIG. 11, the perforations are round, and the area of perforations in the metal film layer 22 is increased by increasing the diameter of the individual perforations, it is recognized that the perforations may alternately be triangular, rectangular or any polygonal shape. While the perforations are preferably regular, basic geometric shapes having easily calculable areas, to facilitate prediction of resulting oxygen diffusion rates, it is recognized that the perforations 28 may be irregularly shaped. It is also recognized that the perforations 28 need not all be of uniform dimension. Optimal oxygen diffusion rates for cap liners may be obtained by varying the number of perforations 28, the size of the perforations 28, and/or the location of the perforations. Additional control over the oxygen diffusion rates can be achieved by varying the type and thickness of the more diffusive layers of the barrier laminate.

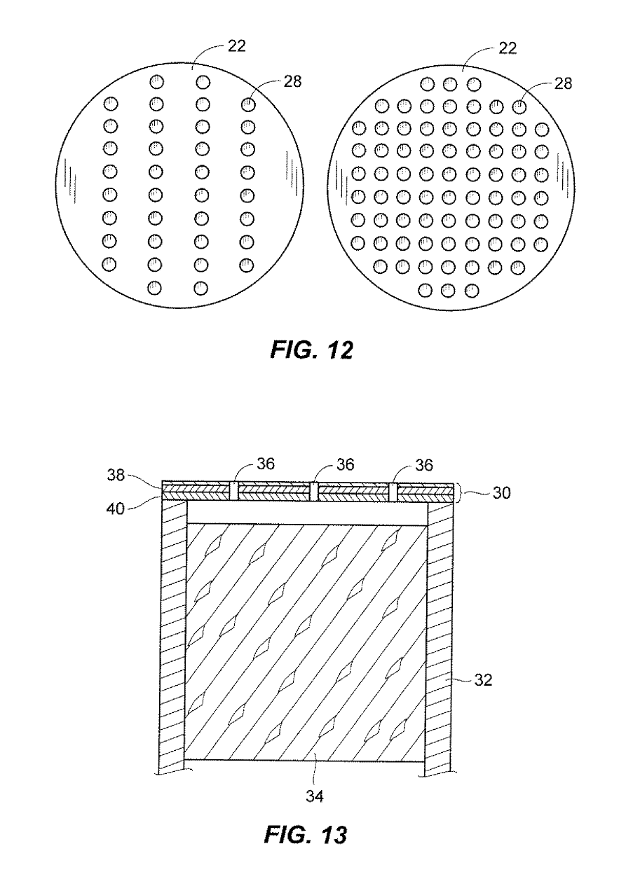

A set of cap liners 10 is also within the scope of the present disclosure, as shown in FIG. 12, wherein each of the cap liners within the set has a perforated metal film layer 22, and at least one of the cap liners 10 of the set has an oxygen diffusion rate different from at least one other of the cap liners 10 of the set. The cumulative area of perforations 28 of each of the at least one cap liners having the greater oxygen diffusion rate is greater than the cumulative area of perforations 28 of each of the cap liners having the lower oxygen diffusion rate.

As an alternate to enlarging the perforations or to increasing the number of perforations, the oxygen diffusion rate can be increased by providing perforations 29 in the PVDC layer 20 in addition to the perforations 28 in the metal film layer 22, as illustrated in FIG. 8.

A standard-sized screw cap liner 10 of the present disclosure has a diameter of 30 mm, and an oxygen diffusion rate greater than 0.0002 cc O₂ per day and less than 0.002 cc O₂ per day. Cap diameters for wine bottles may be provided in a range of about 18 mm to about 38 mm, such as 18 mm, 25 mm, 28 mm, 30 mm, 32 mm, 35 mm and 38 mm, with 30 mm being the most typical. However, utilizing the teachings of the present disclosure, one can adjust or fine-tune the oxygen diffusion rate for a particular bottle by providing liners of appropriate barrier layer perforations to achieve an oxygen diffusion rate in the range of about 0.002 cc O₂ per day to about 0.006 cc O₂ per day.

In a preferred embodiment, a cap liner 10 of the present disclosure includes a first layer of LDPE, a perforated metal film layer 22, a second LDPE layer, a layer of foam or kraft paper, and a third LDPE layer. Alternately, the cap liner 10 may include a first layer of LDPE, a barrier laminate having a perforated PVDC layer 20 but no metal film layer, a layer of foam or kraft paper, and a second layer of LDPE.

Turning to FIG. 13, an over-seal 30 for a glass bottle 32 having a conventional natural or synthetic cork 34 is provided as a laminate, having one or more perforations 36 through all the several layers 38, 40 comprising the laminate. By precisely controlling the size and/or number of the perforation(s) 36, a desired oxygen transmission rate may be achieved. As in the embodiments described above, the perforations may be imparted to the laminate of the over-seal 30 by an appropriate means for providing perforations in a foil or polymer film, including laser, electro-discharge machining (EDM), or other precision techniques for drilling apertures through thin metal or polymer film.

A method for controlling the oxygen diffusion rate of a cap liner 10 is also within the scope of the present disclosure. The method includes forming a liner laminate for a cap liner including first polymer film layer 16, an oxygen barrier laminate 18 provided on the first polymer film layer 16 and a second polymer film layer 26. The method further includes forming one or more perforations 28 in a primary oxygen barrier layer of the barrier laminate. The primary oxygen barrier layer may be a metal foil layer 22. The barrier laminate 18 may also include a PVDC layer 22, and in such case, the method may further include forming perforations in the PVDC layer. Alternatively, the barrier laminate 18 may lack a metal foil layer, but rather, have only a PVDC layer as its primary oxygen barrier layer. In such a case, the method includes forming one or more perforations 28 in the PVDC layer. The laminate may include a fiber card (paper) 24 or polymer foam intermediate the barrier laminate 18 and the second polymer film layer 26.

In at least one embodiment, the method further includes increasing the oxygen diffusion rate of a cap liner 10 by increasing the number of perforations 28 formed in the metal foil or PVDC 22.

In at least one embodiment, the method further includes increasing the oxygen diffusion rate of a cap liner 10 by increasing the size of perforations 28 formed in the metal foil or PVDC 22.

A method of forming a set of cap liners of varying oxygen diffusion rates is also within the scope of the present disclosure. The method includes forming a laminate for a first screw cap liner 10, including a first polymer film layer 16, a barrier laminate 18 provided on the first polymer film layer 16, the barrier laminate 18 including a barrier layer laminate of a PVDC layer 20 and metal foil 22, and a second polymer film layer 26. Prior to assembling the barrier layer laminate of the first cap liner 10, the method further includes forming a plurality of perforations 28 in the metal foil for that barrier layer laminate, the plurality of perforations having a first cumulative area.

The method also includes forming a laminate for a second cap liner having the same components mentioned in the previous paragraph for the laminate for the first cap liner, but prior to assembling the barrier laminate of the second cap liner, the method includes forming a plurality of perforations in the metal foil for that barrier laminate, the plurality of perforations in the metal foil for the second cap liner having a second cumulative area that is greater than the first cumulative area. In selecting a particular cap liner from the set of cap liners for a particular application, the cap liner having an oxygen diffusion rate closest to the optimal oxygen diffusion rate suited to the contents of the bottle for that application may be selected.

The first cap liner of the set may have an oxygen diffusion rate in the range of about 0.0004 to 0.0006 cc O₂ per bottle per day. The second cap liner of the set may have an oxygen diffusion rate in the range of about 0.0007 to 0.0015 cc O₂ per bottle per day.

In one embodiment of this method, more perforations are formed in the metal foil for the second cap liner than are formed in the metal foil for the first cap liner.

In another embodiment of this method, each of the perforations in the metal foil for the second cap liner is larger than each of the perforations in the metal foil for the first cap liner.

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

What is claimed is:

1. A liner for a container closure comprising:
a first polymer film layer;
a barrier layer disposed on the first polymer film layer, the barrier layer having one or more perforations therein; and
a second polymer film layer disposed on a surface of the barrier layer opposite the first polymer film layer.

2. The liner of claim 1, wherein the barrier layer includes a barrier laminate having a metal film layer, the perforations being provided in the metal film layer.

3. The liner of claim 2, wherein the barrier laminate further comprises a layer of PVDC.

4. The liner of claim 1, further comprising a layer disposed intermediate the barrier layer and the second polymer film layer comprising at least one of paper or polymer foam.

5. The liner of claim 1 having a diameter in a range of about 18 mm to about 38 mm and an oxygen diffusion rate greater than 0.0001 cc O₂ per 24 hours and less than 0.006 cc O₂ per 24 hours.

6. The liner of claim 5, wherein the oxygen diffusion rate is in the range of about 0.0004-0.0006 cc O₂ per 24 hours.

7. The liner of claim 5, wherein the oxygen diffusion rate is in the range of about 0.0007-00015 cc O₂ per 24 hours.

8. The liner of claim 1, wherein the barrier layer is a layer of PVDC having an oxygen diffusion rate of about 0.001-0.006 cc O₂ per 24 hours.

9. A set of liners for container closures, wherein each of the liners within the set has a barrier laminate with a perforated oxygen barrier layer, and at least one of the liners of the set has an oxygen diffusion rate different from at least one other of the liners of the set.

10. The set of claim 9, wherein a cumulative area of perforations of each of the at least one liners having a greater oxygen diffusion rate is greater than a cumulative area of perforations of each of the liners having a lower oxygen diffusion rate.

11. The set of claim 9, wherein the oxygen diffusion rate of at least one of the liners is in the range of about 0.0004-0.0006 cc O₂ per 24 hours.

12. The set of claim 9, wherein the oxygen diffusion rate of at least one of the liners is in the range of about 0.0007-0.0015 cc O₂ per 24 hours.

13. A method for controlling the oxygen diffusion rate of a liner comprising:
forming a liner laminate including a first polymer film layer, a barrier laminate, said barrier laminate having one or more layers, one of said layers of the barrier laminate being a primary oxygen barrier layer, said barrier laminate provided intermediate a first polymer film layer and a second polymer film layer; and
forming one or more perforations in the primary oxygen barrier layer of the barrier laminate.

14. The method of claim 13, wherein the barrier laminate includes a metal foil layer as the primary oxygen barrier layer, and the one or more perforations are provided in the metal foil layer of the barrier laminate.

15. The method of claim 13, wherein the barrier laminate includes a PVDC layer as the primary oxygen barrier layer, and the one or more perforations are provided in the PVDC layer of the barrier laminate.

16. The method of claim 13, wherein in forming the liner laminate, providing at least one of paper or polymer foam intermediate the barrier laminate and the second polymer film layer.

17. The method of claim 13, further including increasing the oxygen diffusion rate of a liner by increasing the number of perforations formed in the primary oxygen barrier layer of the barrier laminate.

18. The method of claim 13, further including increasing the oxygen diffusion rate of a liner by increasing the size of perforations formed in the primary oxygen barrier layer of the barrier laminate.

19. The method of claim 13, wherein in forming one or more perforations in the primary oxygen barrier layer of the barrier laminate, using means for providing perforations in a foil or polymer film.

20. A method of forming a set of liners of varying oxygen diffusion rates for container closures, comprising:
forming a laminate for a first liner, said laminate for the first liner including a first polymer film layer, an oxygen barrier layer provided on the first polymer film layer, and a second polymer film layer;
forming a plurality of perforations in the primary oxygen barrier layer, the plurality of perforations having a first cumulative area;
forming a laminate for a second liner, said laminate for the second liner including a first polymer film layer, an oxygen barrier layer provided on the first polymer film layer, and a second polymer film layer; and
forming a plurality of perforations in the primary oxygen barrier layer of the barrier laminate of the second liner, the plurality of perforations in the primary oxygen barrier layer of the second liner having a second cumulative area that is greater than the first cumulative area.

21. The method of claim 20, wherein in forming the plurality of perforations in the primary oxygen barrier layer of the first and second liners, forming a greater number of perforations in the primary oxygen barrier layer of for the second liner than in the primary oxygen barrier layer of the first liner.

22. The method of claim 21, wherein in forming the plurality of perforations in the primary oxygen barrier layer of the first and second liners, forming one or more of the perforations in the primary oxygen barrier layer of the second liner of a greater size than the perforations in the primary barrier layer of the first liner.

23. The method of claim 21, wherein in forming the plurality of perforations in the primary oxygen barrier layer of the first and second liners, forming one or more of the perforations in a metal foil layer of each of the oxygen barrier laminates.

24. The method of claim 21, wherein in forming the plurality of perforations in the primary barrier layer of the first and second liners, forming one or more of the perforations in a PVDC layer of each of the oxygen barrier laminates.

25. A laminate over-seal for a container closure comprising:
a first polymer film layer;
an oxygen barrier layer disposed on the first polymer film layer, the oxygen barrier layer having one or more perforations therein; and
a second polymer film layer disposed on a surface of the oxygen barrier layer opposite the first polymer film layer.
